(19) United States
(12) Patent Application Publication
(10) Pub. No.: US 2015/0305305 A1
(43) Pub. Date: Oct. 29, 2015

(54) MULTIFUNCTIONAL PET TOY

(71) Applicant: Wondereye Technology Corp., New Taipei City (TW)

(72) Inventors: CHIA-LUN LIU, New Taipei City (TW); CHIN-SHAN TSAI, New Taipei City (TW)

(73) Assignee: Wondereye Technology Corp.

(21) Appl. No.: 14/694,394

(22) Filed: Apr. 23, 2015

(30) Foreign Application Priority Data
Apr. 29, 2014 (TW) 103207448

(51) Int. Cl. A01K 15/02

(52) U.S. Cl. CPC A01K 15/025

(57) ABSTRACT

The present invention provides a multifunctional pet toy, comprising: a spinning device comprising: a base, a spinning portion provided on the base and to be driven to spin by a driving device, and a mounting portion provided on an outer periphery of the spinning portion and configured to be mounted with an accessory; an annular track provided along an outer periphery of the spinning device, the annular track comprising a track portion and a rolling element provided in the track portion; and a computation unit connected to the driving device and configured to generate, according to a command signal received or a random calculation, a motion command for controlling motion of the spinning portion.

### BACKGROUND OF THE INVENTION

1. Technical Field

The present invention relates to a multifunctional pet toy and, more particularly, to a multifunctional pet toy which can be played in many ways to produce a diversity of interactions between a pet owner and his or her pet(s).

2. Description of Related Art

Pet toys are intended mainly to enhance the emotional bonds between pet owners and their pets and to increase the latter's trust in the former through pet-owner interactions. From a designer's point of view, a well-designed pet toy is one that can arouse a pet's interest, and things known to attract a pet's attention include special smells, sounds of specific frequencies, and fast moving objects, for example. Pet toy designs, therefore, are generally based on such attention-compelling factors in order to appeal to pets.

Currently, the market is supplied with a good variety of pet toys, and variations in pet toys designed on pets' interests abound. However, most pet toys can be played in only one way and hence fail to secure pets' attention for a long time. In light of this, the pet toy industry is making great efforts to incorporate various playing methods into a single pet toy.

### BRIEF SUMMARY OF THE INVENTION

It is an objective of the present invention to provide a pet toy which can be played in many different ways and which therefore gives a pet owner more options in using the pet toy.

To solve the issue stated above, it is an objective of the present invention to provide a multifunctional pet toy, comprising: a spinning device comprising: a base, a spinning portion provided on the base and to be driven to spin by a driving device, and a mounting portion provided on an outer periphery of the spinning portion and configured to be mounted with an accessory; an annular track provided along an outer periphery of the spinning device, the annular track comprising a track portion and a rolling element provided in the track portion; and a computation unit connected to the driving device and configured to generate, according to a command signal received or a random calculation, a motion command for controlling motion of the spinning portion.

Preferably, the driving device comprises a motor, a rotation mechanism to be driven by the motor in order to drive the spinning portion to spin, and a sensor connected to the computation unit and provided on or on one side of the rotation mechanism; and the computation unit comprises a protection state, into which the computation unit enters upon the sensor detecting that the rotation mechanism is stopped and in which the computation unit stops operation of the motor, and a working state, into which the computation unit enters after staying in the protection state for a time longer than a threshold value and in which the computation unit brings the motor back into operation.

Preferably, the computation unit comprises an automatic control mode in which the computation unit generates the motion command according to random numbers generated from the random calculation.

Preferably, the computation unit comprises a manual control mode in which the computation unit generates the motion command according to the command signal inputted via a user interface connected to the computation unit.

Preferably, the user interface comprises a wireless receiving unit connected to the computation unit and a remote control coupled to the wireless receiving unit, and the remote control comprises a wireless transmission unit and a control interface connected to the wireless transmission unit in order to transmit the command signal to the computation unit.

Preferably, the remote control comprises a laser pointer.

Preferably, the accessory is a ball-hitting plate comprising a main body portion, a connecting portion provided on one side of the main body portion and mountable to the mounting portion, and a ball-hitting portion which is provided on a side of the main body portion that is opposite the connecting portion and which extends into the track portion.

Preferably, the accessory is a ball-shielding plate comprising a main body portion, a connecting portion provided on one side of the main body portion and mountable to the mounting portion, and a ball-shielding portion which is provided on a side of the main body portion that is opposite the connecting portion and which corresponds to an upper side of the track portion.

Preferably, the accessory is a bent bar comprising a straight bar portion, a connecting portion provided on one side of the straight bar portion and mountable to the mounting portion, a bent bar portion which is connected to a side of the straight bar portion that is opposite the connecting portion and which is bent relative to the straight bar portion, and a hole portion provided on the bent bar portion and configured to be mounted with a teasing accessory.

Preferably, the driving device comprises a motor, a rotation mechanism to be driven by the motor in order to drive the spinning portion to spin, and a clutch gear set provided between the motor and the rotation mechanism; the clutch gear set comprises a lower clutch gear to be driven by the motor, an upper clutch gear connected to the rotation mechanism and coaxial with the lower clutch gear, and an elastic element coaxial with the upper clutch gear; and the clutch gear set comprises a separated state, into which the clutch gear set enters upon the rotation mechanism being subjected to a radial resistance and in which the upper clutch gear and the lower clutch gear are separated, and a connected state, into which the clutch gear set enters upon disappearance of the radial resistance and in which the lower clutch gear and the upper clutch gear are reconnected due to an axial force applied by the elastic element.

Compared with the prior art, embodiments of the present invention have the following advantageous technical effects:

1. A pet toy featuring various playing methods is provided to give a pet owner more options in using the pet toy.

2. The multifunctional pet toy of the present invention can be switched to an automatic control mode so that a pet can play the pet toy on its own.

3. The multifunctional pet toy of the present invention can also be switched to a manual control mode so that a pet owner can interact with his or her pet(s) remotely via a remote control.

4. The present invention uses a clutch gear set whose upper and lower clutch gears can interact with a rotation mechanism to render motor operation independent of the rotation mechanism, thereby protecting the motor from damage resulting from a pet putting its weight on the spinning device.

5. A sensor is used in the present invention to detect the operation state of the rotation mechanism, with a view to preventing motor damage attributable to a pet putting its weight on the spinning device.

### BRIEF DESCRIPTION OF THE SEVERAL VIEWS OF THE DRAWINGS

FIG. 1 is a perspective view of the multifunctional pet toy in an embodiment of the present invention;

FIG. 2 is an exploded perspective view of the multifunctional pet toy in FIG. 1:

FIG. 3 is a block diagram of the multifunctional pet toy in FIG. 1;

FIG. 4 is a perspective view of the remote control in the present invention;

FIG. 5 is a perspective view showing the multifunctional pet toy in FIG. 1 mounted with a ball-hitting plate;

FIG. 6 is a perspective view showing the multifunctional pet toy in FIG. 1 mounted with a ball-shielding plate;

FIG. 7 is a perspective view showing the multifunctional pet toy in FIG. 1 mounted with a bent bar; and

FIG. 8 is an exploded perspective view of the multifunctional pet toy in another embodiment of the present invention.

### DETAILED DESCRIPTION OF THE INVENTION

The technical content of the present invention is detailed below with reference to the accompanying drawings. Please note that the drawings are not necessarily drawn to scale and may include components which are exaggerated in proportion to facilitate description. Therefore, the drawings and the proportions of the components depicted therein should not be construed as restrictive of the scope of the present invention.

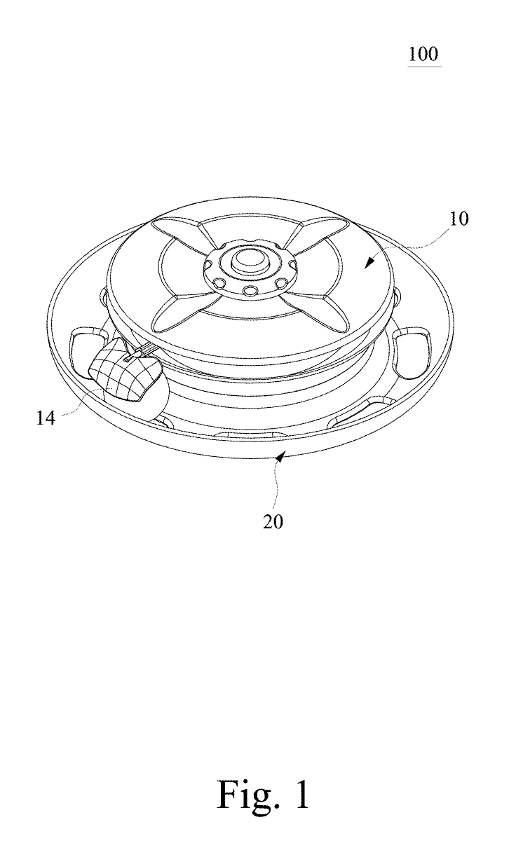

Please refer to FIG. 1 for a perspective view of the multifunctional pet toy in an embodiment of the present invention.

In the embodiment shown in FIG. 1, a multifunctional pet toy 100 is provided which can be played in many ways thanks mainly to the corresponding relationship between the spinning device 10 and the annular track 20. Not only can the multifunctional pet toy 100 be switched between an automatic control mode and a manual control mode, but also the spinning device 10 can be mounted with different accessories 14 to provide even more playing methods to enrich pet-owner interactions.

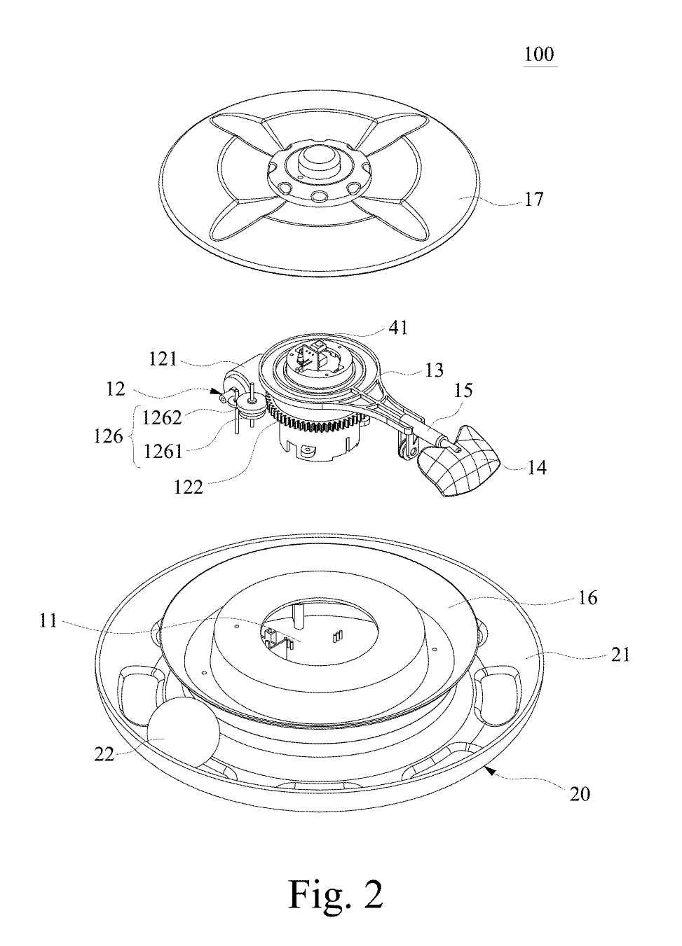

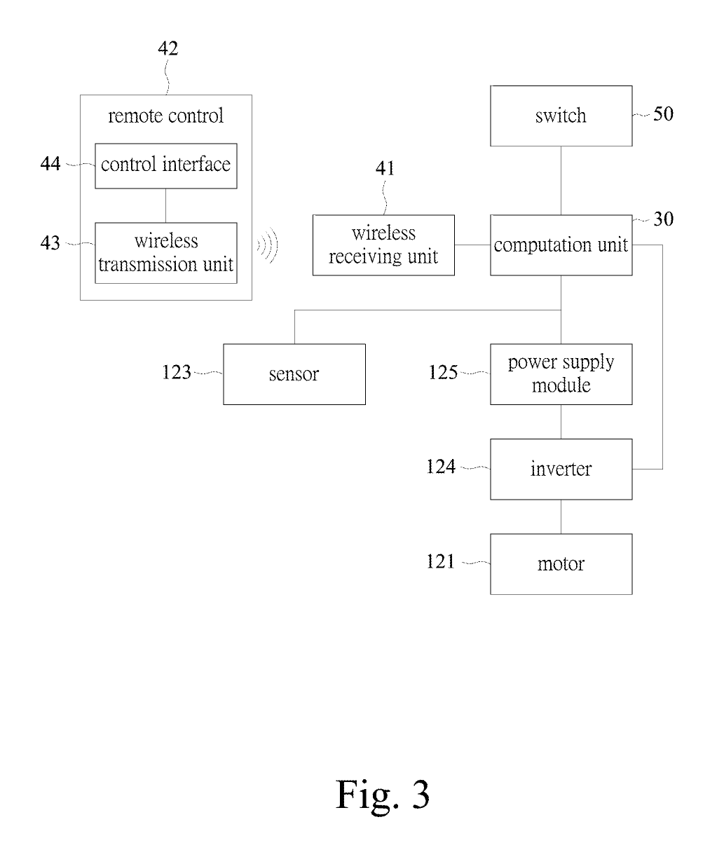

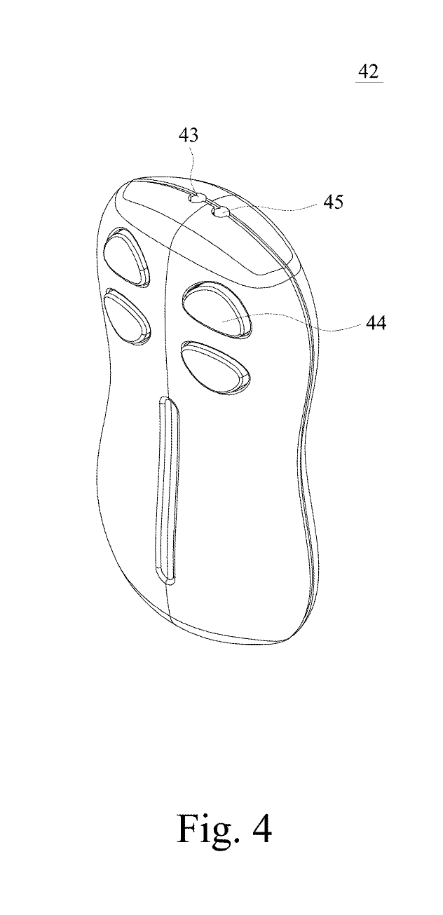

The structural details of the multifunctional pet toy are now described with reference also to FIG. 2, FIG. 3, and FIG. 4, which are an exploded perspective view and a block diagram of the multifunctional pet toy and a perspective view of the remote control for use with the multifunctional pet toy, respectively.

As shown in the drawings, the multifunctional pet toy 100 essentially includes the spinning device 10, the annular track 20 provided along the outer periphery of the spinning device 10, a computation unit 30 connected to the spinning device 10, and a user interface connected to the computation unit 30.

The computation unit 30 is provided on a circuit board 60. In this embodiment, the circuit board 60 is also provided with an inverter 124 connected to the computation unit 30, a power supply module 125 furnished with batteries (not shown), and a switch 50.

The spinning device 10 includes a base 11, a spinning portion 13 provided on the base 11 and to be driven to spin by a driving device 12, a mounting portion 15 provided on the outer periphery of the spinning portion 13 and configured to be mounted with an accessory 14, a lower cover 16 provided above the base 11 in order to cover the internal components, and an upper cover 17 provided above the spinning portion 13 in order to cover the spinning portion 13. The driving device 12 includes a motor 121, a rotation mechanism 122 to be driven by the motor 121 in order to drive the spinning portion 13 to spin, the power supply module 125 connected to the motor 121, and a clutch gear set 126 connected to the motor 121 and the rotation mechanism 122. The switch 50 is configured for manual operation by the user so as to switch the computation unit 30 to different modes, including a sleep mode. In this embodiment, the motor 121 corresponds to the inverter 124, which controls the rotation direction of the motor 121 and thereby determines whether the spinning portion 13 spins clockwise or counterclockwise. The upper cover 17 and the lower cover 16 are properly spaced apart such that a groove through which the mounting portion 15 can extend is formed. The mounting portion 15 can be mounted with different accessories 14, whose operations will be described in more detail below. The rotation mechanism 122 is a gear module composed of a plurality of gear mechanisms. By varying the gear ratio between the gear mechanisms in the gear module, the spinning speed of the spinning portion 13 can be adjusted. It is understood, however, that the rotation mechanism described above is only one feasible mechanism for use in the present invention and should not be construed as restrictive of the scope of the present invention.

The annular track 20 is connected to the base 11 and is provided along the outer periphery of the base 11 so as to correspond to the spinning portion 13. The annular track 20 essentially includes a track portion 21 and a rolling element 22 provided in the track portion 21. In this embodiment, the track portion 21 has a bowl-shaped structure, and a curved groove is provided on the inner side of the bowl-shaped structure. Consequently, a position-limiting space is formed between the curved groove and the lower cover 16 to prevent the rolling element 22 from escaping the curved groove. The bottom side of the curved groove is provided with a plurality of through holes corresponding to the rolling element 22.

The computation unit 30 is connected to the driving device 12. The computation unit 30 can be a central processing unit (CPU), a programmable general-purpose or application-specific microprocessor, a digital signal processor (DSP), a programmable controller, an application-specific integrated circuit (ASIC), a programmable logic device (PLD), or the like, or a combination thereof. In the present invention, programs can be loaded from a storage unit into the computation unit 30 in order for the computation unit 30 to execute commands corresponding respectively to various modes.

Referring to FIG. 3 and FIG. 4, the user interface in the present invention refers to any user interface (UI) that is designed to be operated by the user. For instance, the user interface can be a keyboard, sound input device, touch screen, or other similar input device. In a preferred embodiment of the present invention, the user interface includes a wireless receiving unit 41 connected to the computation unit 30 and a remote control 42 coupled to the wireless receiving unit 41.

The remote control 42 includes a wireless transmission unit 43, a control interface 44 connected to the wireless transmission unit 43, and a laser pointer 45. The wireless transmission unit 43 is coupled to the wireless receiving unit 41 in order to transmit wirelessly to the computation unit 30 the command signal inputted via the control interface 44. Preferably, wireless transmission is carried out by infrared transmission, Bluetooth transmission, or radio transmission; the present invention imposes no limitations in this regard. The control interface 44 is configured to send the command signal through the wireless transmission unit 43 to the computation unit 30. The command signal includes clockwise spin, counterclockwise spin, and pause and is used to control the spinning device 10 by way of the computation unit 30. The laser pointer 45 can generate a light spot for attracting a pet's attention and preferably has an output power ranging from 1 mW to 5 mW. This range of output power is known to cause relatively minor injury to the eye and therefore should be adopted to prevent injury to a pet's eyes.

The multifunctional pet toy 100 of the present invention can be switched between the automatic control mode and the manual control mode according to the user's needs. Once the multifunctional pet toy 100 is switched via the switch 50 to the automatic control mode, the computation unit 30 operates in an automatic control state, in which the computation unit 30 randomly generates a random number code, issues a motion command to the driving device 12 according to the random number code, and thereby drives the spinning portion 13 into an irregular spinning motion based on the random number code. Once the multifunctional pet toy is switched via the switch 50 to the manual control mode, the computation unit 30 operates in a manual control state, in which the computation unit 30 generates a motion command according to the command signal inputted by the user through the user interface, the motion command including a clockwise spin command, a counterclockwise spin command, and a pause command.

To protect the motor 121 from damage by an unexpected radial resistance resulting from a pet patting or putting its weight on the spinning portion 13, the driving device 12 of the multifunctional pet toy 100 of the present invention is provided with the clutch gear set 126, which is provided between the motor 121 and the rotation mechanism 122 and is designed to prevent unexpected radial resistance applied to the motor 121 by a pet patting or putting its weight on the spinning portion 13 from damaging the motor 121. The clutch gear set 126 includes a lower clutch gear 1261 to be driven by the motor 121, an upper clutch gear 1262 connected to the rotation mechanism 122 and coaxial with the lower clutch gear 1261, and an elastic element (not shown) coaxial with the upper clutch gear 1262.

During normal operation, the motor 121 drives the lower clutch gear 1261 into rotation, and the torque is delivered to the upper clutch gear 1262, thereby driving the rotation mechanism 122 to rotate. When the rotation mechanism 122 is subjected to a radial resistance, the upper clutch gear 1262 stops rotation immediately, but the lower clutch gear 1261 continues being rotated by the motor 121. As a result, the bevel gears between the upper clutch gear 1262 and the lower clutch gear 1261 begin to slide relative to each other, and the clutch gear set 126, to work in the separated state without bringing the motor 121 to a halt, thus protecting the motor 121 from damage. When the radial resistance disappears, the elastic element applies an axial force such that the lower clutch gear 1261 and the upper clutch gear 1262 are connected again. The clutch gear set 126, therefore, starts working in the connected state.

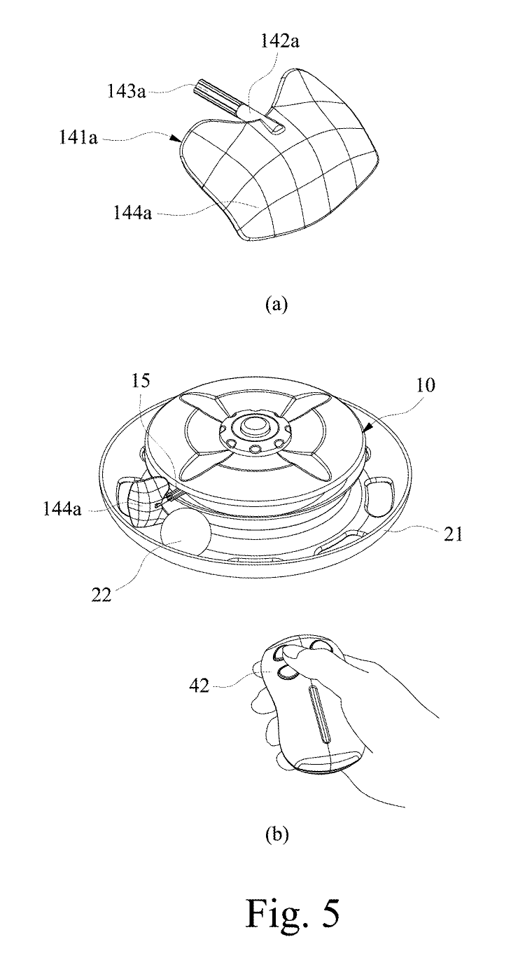

FIG. 5(a) and FIG. 5(b) show the multifunctional pet toy mounted with a ball-hitting plate.

In a preferred embodiment of the present invention as shown in FIG. 5(a) and FIG. 5(b), the accessory 14 is a ball-hitting plate 141a. The ball-hitting plate 141a includes a main body portion 142a, a connecting portion 143a provided on one side of the main body portion 142a and mountable to the mounting portion 15, and a ball-hitting portion 144a provided on the opposite side of the main body portion 142a (i.e., the side opposite the connecting portion 143a) and extending into the track portion 21. When the computation unit 30 is switched to the automatic control mode, the spinning device 10 spins in an irregular manner and hits the rolling element 22 with the ball-hitting plate 141a in the same manner, in order for the rolling element 22 to move along an irregular path to secure a pet's attention. When the computation unit 30 is switched to the manual control mode, the spinning device 10 is remotely controllable by the remote control 42, allowing the user to hit the rolling element 22 with the ball-hitting plate 141a by operating the remote control 42 and thus drive the rolling element 22 into clockwise or counterclockwise rotation.

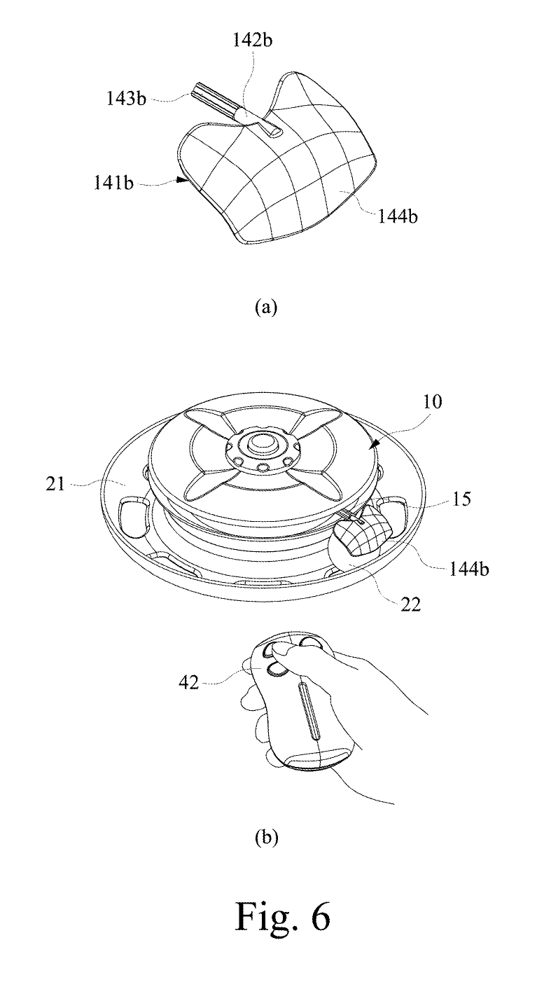

FIG. 6(a) and FIG. 6(b) show the multifunctional pet toy mounted with a ball-shielding plate.

In a preferred embodiment of the present invention as shown in FIG. 6(a) and FIG. 6(b), the accessory 14 is a ball-shielding plate 141b. The ball-shielding plate 141b includes a main body portion 142b, a connecting portion 143b provided on one side of the main body portion 142b and mountable to the mounting portion 15, and a ball-shielding portion 144b provided on the opposite side of the main body portion 142b (i.e., the side opposite the connecting portion 143b) and corresponding to an upper side of the track portion 21. When the computation unit 30 is switched to the automatic control mode, the spinning device 10 spins in an irregular manner and shields the rolling element 22 with the ball-shielding plate 141b in the same manner to attract a pet's attention. In addition, the ball-shielding plate 141b may pat the pet's paw while being moved. When the computation unit 30 is switched to the manual control mode, the spinning device 10 is remotely controllable by the remote control 42, allowing the user to drive the spinning device 10 into clockwise or counterclockwise spinning motion by operating the remote control 42 and thus shield the rolling element 22 (and/or pat a pet's paw) with the ball-shielding plate 141b either clockwise or counterclockwise.

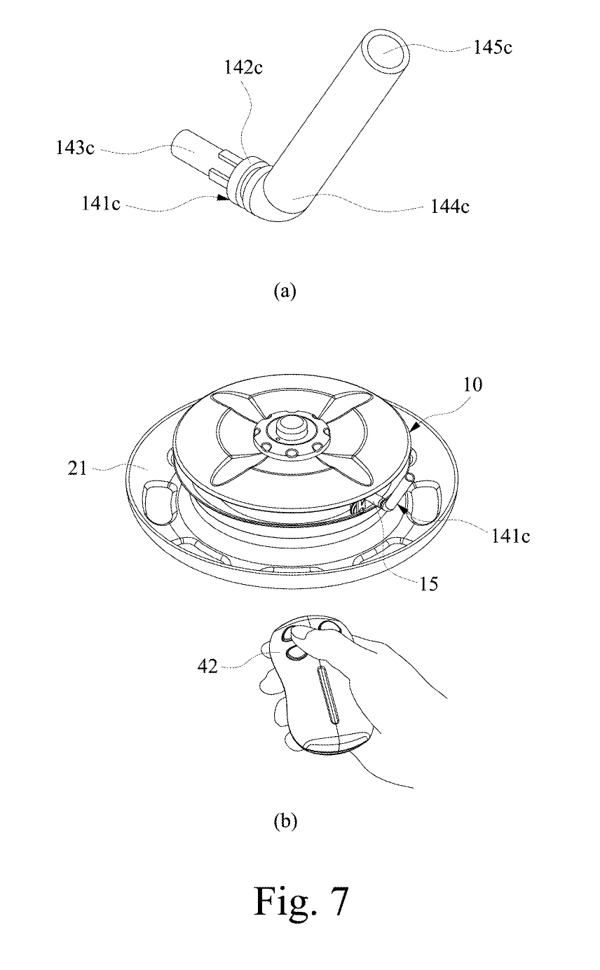

FIG. 7(a) and FIG. 7(b) show the multifunctional pet toy mounted with a bent bar.

In a preferred embodiment of the present invention as shown in FIG. 7(a) and FIG. 7(b), the accessory 14 is a bent bar 141c. The bent bar 141c includes a straight bar portion 142c, a connecting portion 143c provided on one side of the straight bar portion 142c and mountable to the mounting portion 15, a bent bar portion 144c connected to the opposite side of the straight bar portion 142c (i. ., the side opposite the connecting portion 143c) and bent relative to the straight bar portion 142c, and a hole portion 145c provided on the bent bar portion 144c and configured to be mounted with a teasing accessory. The hole portion 145c can be fitted with a cat-teasing stick, ribbon stick, or other teasing accessory that can be fitted into the hole portion 145c; the present invention imposes no limitations in this respect. When the computation unit 30 is switched to the automatic control mode, the spinning device 10 spins in an irregular manner and spins the bent bar 141c, and consequently the teasing accessory, in the same manner to attract a pet's attention. The teasing accessory may also pat the pet's paw while being moved. When the computation unit 30 is switched to the manual control mode, the spinning device 10 is remotely controllable by the remote control 42, allowing the user to drive the spinning device 10 into clockwise or counterclockwise spinning motion by operating the remote control 42 and thus tease the pet (and/or pat the pet's paw) with the teasing accessory.

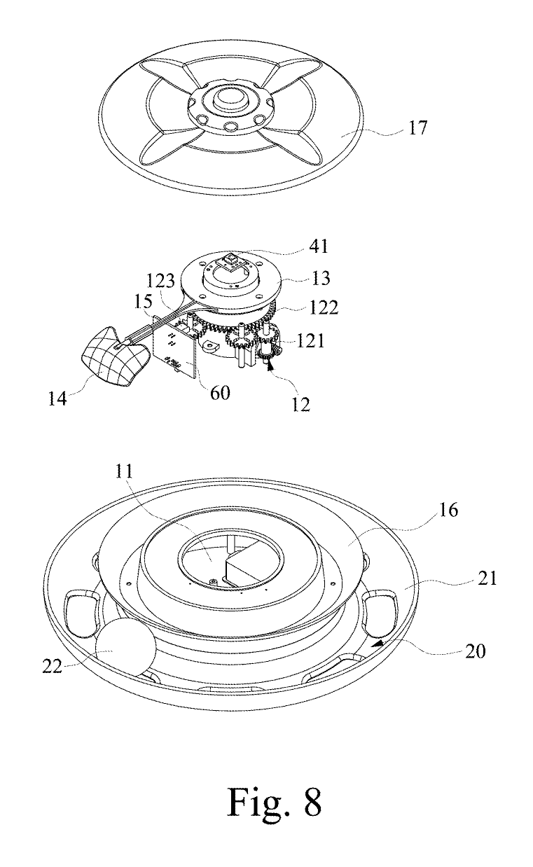

FIG. 8 shows the multifunctional pet toy in another embodiment of the present invention in an exploded perspective view.

In the embodiment shown in FIG. 8, a sensor 123 is provided in place of the clutch gear set 126 in order to protect the motor 121. Unlike the embodiment described above, this embodiment uses the sensor 123 to detect the motion of the rotation mechanism 122 so as to switch automatically between a protection mode and a working mode. When the sensor 123 detects that the rotation mechanism 122 is stopped, the computation unit 30 is brought into a protection state, in which the computation unit 30 sends a stop command to the power supply module 125 of the motor 121, and by cutting off the power supplied to the motor 121, the motor 121 is temporarily turned off. When the computation unit 30 stays in the protection state for a time longer than a threshold value, it is brought into a working state, in which the computation unit 30 sends an operation command to the power supply module 125 of the motor 121 so that the motor 121 resumes operation.

According to the above, the manner in which the spinning portion and the annular track of the present invention are arranged with respect to each other enables different playing methods and allows a pet owner to interact with his or her pet(s) in various ways. Moreover, the multifunctional pet toy of the present invention can be switched between automatic control and manual control so that a pet owner has a lot of pet-owner interaction modes to choose from. Not only that, the clutch gear set in the present invention can determine the operation state of the rotation mechanism in order to prevent the motor from damage by a pet putting its weight on the spinning device.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A multifunctional pet toy, comprising:
a spinning device comprising: a base, a spinning portion provided on the base and to be driven to spin by a driving device, and a mounting portion provided on an outer periphery of the spinning portion and configured to be mounted with an accessory;
an annular track provided along an outer periphery of the spinning device, the annular track comprising a track portion and a rolling element provided in the track portion; and
a computation unit connected to the driving device and configured to generate, according to a command signal received or a random calculation, a motion command for controlling motion of the spinning portion.

2. The multifunctional pet toy of claim 1, wherein the driving device comprises a motor, a rotation mechanism to be driven by the motor in order to drive the spinning portion to spin, and a sensor connected to the computation unit and provided on or on one side of the rotation mechanism; and the computation unit comprises a protection state, into which the computation unit enters upon the sensor detecting that the rotation mechanism is stopped and in which the computation unit stops operation of the motor, and a working state, into which the computation unit enters after staying in the protection state for a time longer than a threshold value and in which the computation unit brings the motor back into operation.

3. The multifunctional pet toy of claim 1, wherein the computation unit comprises an automatic control mode in which the computation unit generates the motion command according to random numbers generated from the random calculation.

4. The multifunctional pet toy of claim 1, wherein the computation unit comprises a manual control mode in which the computation unit generates the motion command according to the command signal inputted via a user interface connected to the computation unit.

5. The multifunctional pet toy of claim 4, wherein the user interface comprises a wireless receiving unit connected to the computation unit and a remote control coupled to the wireless receiving unit, and the remote control comprises a wireless transmission unit and a control interface connected to the wireless transmission unit in order to transmit the command signal to the computation unit.

6. The multifunctional pet toy of claim 5, wherein the remote control comprises a laser pointer.

7. The multifunctional pet toy of claim 1, wherein the accessory is a ball-hitting plate comprising a main body portion, a connecting portion provided on one side of the main body portion and mountable to the mounting portion, and a ball-hitting portion which is provided on a side of the main body portion that is opposite the connecting portion and which extends into the track portion.

8. The multifunctional pet toy of claim 1, wherein the accessory is a ball-shielding plate comprising a main body portion, a connecting portion provided on one side of the main body portion and mountable to the mounting portion, and a ball-shielding portion which is provided on a side of the main body portion that is opposite the connecting portion and which corresponds to an upper side of the track portion.

9. The multifunctional pet toy of claim 1, wherein the accessory is a bent bar comprising a straight bar portion, a connecting portion provided on one side of the straight bar portion and mountable to the mounting portion, a bent bar portion which is connected to a side of the straight bar portion that is opposite the connecting portion and which is bent relative to the straight bar portion, and a hole portion provided on the bent bar portion and configured to be mounted with a teasing accessory.

10. The multifunctional pet toy of claim 1, wherein the driving device comprises a motor, a rotation mechanism to be driven by the motor in order to drive the spinning portion to spin, and a clutch gear set provided between the motor and the rotation mechanism; the clutch gear set comprises a lower clutch gear to be driven by the motor, an upper clutch gear connected to the rotation mechanism and coaxial with the lower clutch gear, and an elastic element coaxial with the upper clutch gear; and the clutch gear set comprises a separated state, into which the clutch gear set enters upon the rotation mechanism being subjected to a radial resistance and in which the upper clutch gear and the lower clutch gear are separated, and a connected state, into which the clutch gear set enters upon disappearance of the radial resistance and in which the lower clutch gear and the upper clutch gear are reconnected due to an axial force applied by the elastic element.
